(19) United States
(12) Patent Application Publication
(10) Pub. No.: US 2026/0186347 A1
(43) Pub. Date: Jul. 2, 2026

(54) VERTICALLY ALIGNED LIQUID CRYSTAL MODULATOR FOR VOLTAGE IMAGE DISPLAY INSPECTION

(71) Applicant: Orbotech Ltd., Yavne (IL)

(72) Inventors: Karla G. Gutierrez Cuevas, San Jose, CA (US); Chai Lor, Hayward, CA (US)

(21) Appl. No.: 19/006,662

(22) Filed: Dec. 31, 2024

(51) Int. Cl. G02F 1/1337; G02F 1/1335; G02F 1/1343; H04N 23/56

(52) U.S. Cl. CPC G02F 1/133742; H04N 23/56; G02F 1/133502; G02F 1/133528; G02F 1/133553; G02F 1/13439; G02F 2201/503

(57) ABSTRACT

An electro-optic modulator includes a glass layer, which may include a conductive layer. A first homeotropic alignment layer is disposed on the glass layer. A liquid crystal layer is disposed on the first homeotropic alignment layer opposite the glass layer. A second homeotropic alignment layer is disposed on the liquid crystal layer opposite the first homeotropic alignment layer. A reflective mirror is disposed on the second homeotropic alignment layer opposite the liquid crystal layer. The liquid crystal layer includes a negative dielectric liquid crystal.

### FIELD OF THE DISCLOSURE

This disclosure relates to electro-optics and, more particularly, to liquid crystal materials used in electro-optic applications.

### BACKGROUND OF THE DISCLOSURE

Electro-optic modulators using liquid crystals, particularly nematic curvilinear aligned phases (NCAP) films or polymer dispersed liquid crystal (PDLC) films, for modulation are used to test conduction of thin-film transistors and interconnects of flat panel displays (FPD) under fabrication. Enhancement on defect detection is encouraged to resolve smaller defects on FPDs quickly. Existing modulators had a limit on defect detection capability and low sensitivity.

Current modulator fabrication methods use a stack of different layers. The relevant layers include a thick glass block, a conductive layer, an NCAP layer, a dielectric mirror, and a hard coat. These are assembled in a production line, but had batch-to-batch variations for the NCAPs. Manufacturing processes may need lower sensitivity for resolving small defects (e.g., 15 μm or smaller). An improved modulator is needed.

### BRIEF SUMMARY OF THE DISCLOSURE

An electro-optic modulator is provided in a first embodiment. The electro-optic modulator includes a glass layer; a first homeotropic alignment layer disposed on the glass layer; a liquid crystal layer disposed on the first homeotropic alignment layer opposite the glass layer; a second homeotropic alignment layer disposed on the liquid crystal layer opposite the first homeotropic alignment layer; and a reflective mirror disposed on the second homeotropic alignment layer opposite the liquid crystal layer. The liquid crystal layer includes a negative dielectric liquid crystal.

The electro-optic modulator may include a polarizer disposed on the glass layer opposite the first homeotropic alignment layer. An antireflective layer may be disposed between the polarizer and the first homeotropic alignment layer.

The electro-optic modulator may include a conductive layer disposed between the glass layer and the first homeotropic alignment layer. The conductive layer may be a transparent electrode.

The electro-optic modulator may include a hard coating layer disposed on the reflective mirror oppositive the second homeotropic alignment layer.

The liquid crystal layer may include vertical alignment layers.

An imaging system is provided in a second embodiment. The imaging system includes an illumination source configured to generate illumination; a stage configured to hold a sample; a detector to generate an image of at least a portion of the sample; and an electro-optic modulator disposed in a path of illumination from the illumination source and separated from the sample by an air gap. The electro-optic modulator includes a glass layer; a first homeotropic alignment layer disposed on the glass layer; a liquid crystal layer disposed on the first homeotropic alignment layer opposite the glass layer; a second homeotropic alignment layer disposed on the liquid crystal layer opposite the first homeotropic alignment layer; and a reflective mirror disposed on the second homeotropic alignment layer opposite the liquid crystal layer. The liquid crystal layer includes a negative dielectric liquid crystal.

The electro-optic modulator may include a polarizer disposed on the glass layer opposite the first homeotropic alignment layer. An antireflective layer may be disposed between the polarizer and the first homeotropic alignment layer.

The electro-optic modulator may include a conductive layer disposed between the glass layer and the first homeotropic alignment layer. The conductive layer may be a transparent electrode.

The electro-optic modulator may include a hard coating layer disposed on the reflective mirror oppositive the second homeotropic alignment layer.

The liquid crystal layer may include vertical alignment layers.

### DESCRIPTION OF THE DRAWINGS

For a fuller understanding of the nature and objects of the disclosure, reference should be made to the following detailed description taken in conjunction with the accompanying drawings, in which:

FIG. 1 is a cross-sectional view of an electro-optic modulator in accordance with an embodiment of the present disclosure;

FIG. 2 illustrates a view of a liquid crystal layer of an electro-optic modulator;

FIG. 3 illustrates the liquid crystals of the liquid crystal layer of FIG. 2 after applying an electric field;

FIG. 4 illustrates a diagram of an imaging system in accordance with the present disclosure;

FIG. 5 is an exemplary S-curve in accordance with the present disclosure;

FIG. 6 is a formula for an exemplary liquid crystal structure; and

FIG. 7 is a flowchart of an embodiment of assembling an electro-optic modulator in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein uses a liquid crystal modulator in electro-optic modulators that are used in an array checker modulator technology to enhance the contrast ratio between the off/on state in the film. The liquid crystal modulator can use vertical alignment layers and a negative dielectric liquid crystal to improve defect detection capabilities. The embodiments disclosed herein can provide higher sensitivity, reduced voltage operation, reduced batch-to-batch variations, and a faster assembly process.

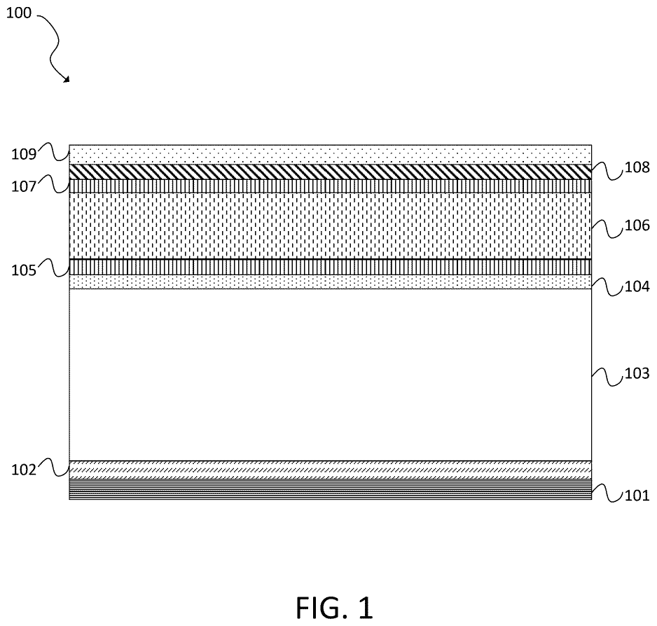

FIG. 1 is a cross-section view of an electro-optic modulator 100. The electro-optic modulator 100 may include one or more films, layers, or coatings. The one or more film layers selectively permit the transmissivity of light. Other films, layers, or coatings besides those illustrated or described with the electro-optic modulator 100 are possible. Layers in the electro-optic modulator may be in direct contact without additional layers between. Layers in the electro-optic modulator also may include additional layers between them.

The electro-optic modulator 100 includes a polarizer 101. An antireflective layer 102 is disposed on the polarizer 101. A glass layer 103 is disposed on the antireflective layer 102. A conductive layer 104 is disposed on the glass layer 103. The conductive layer 104 may be transparent. In an instance, the conductive layer 104 is a transparent electrode.

A first homeotropic alignment layer 105 is disposed on the conductive layer 104. The electro-optic modulator 100 also includes a second homeotropic alignment layer 107. The first homeotropic alignment layer 105 and the second homeotropic alignment layer 107 can be fabricated with polyimides that provide homeotropic alignment to liquid crystals. The first homeotropic alignment layer 105 and the second homeotropic alignment layer 107 can be spin coated into the glass/conductive layer substrate and then baked.

A liquid crystal layer 106 is disposed between the first homeotropic alignment layer 105 and the second homeotropic alignment layer 107. Thus, the liquid crystal layer 106 is disposed on the first homeotropic alignment layer 105 opposite the glass layer 103. The second homeotropic alignment layer 107 is disposed on the liquid crystal layer 106 opposite the first homeotropic alignment layer 105. The liquid crystal layer 106 is a liquid crystal with negative dielectric anisotropy.

A reflective mirror 108 is disposed on the second homeotropic alignment layer 107 opposite the liquid crystal layer 106. A hard coating layer 109 is disposed on the reflective mirror 108 oppositive the second homeotropic alignment layer 107. The hard coating layer 108 may be added to the top of an electro-optic modulator 100 to protect the electro-optic modulator 100. The hard coating layer 108 can be a material described in U.S. Pat. No. 7,099,067, which is incorporated by reference in its entirety.

Light transmission through the liquid crystal layer 106 may change in accordance with a magnitude of an electric field applied to the electro-optic modulator 100. The conductive layer 104 may capacitively couple with a sample to induce a localized voltage and an electric field. The localized voltage may generate the electric field. The electric field causes the liquid crystals in the liquid crystal layer 106 to align perpendicularly to the direction of the electric field.

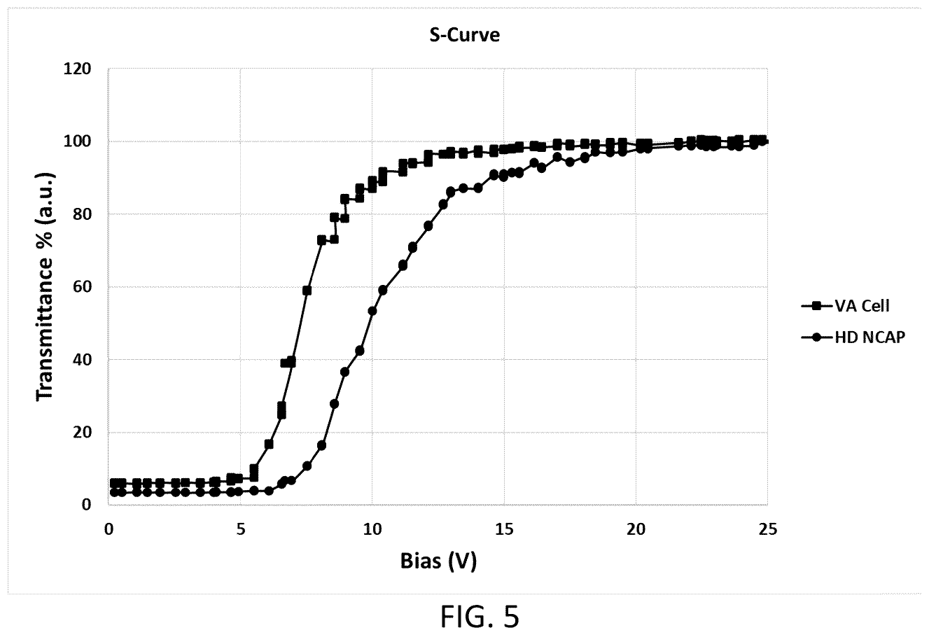

Liquid crystal technology can improve the resolution of defects using the electro-optic modulator 100. The electro-optic modulator 100 can be fabricated by using negative dielectric liquid crystals, spacers, and homeotropic alignment layers on the glass layer 103 and reflective mirror 108. The negative dielectric liquid crystals may have a size from approximately 2 to 3 nm with negative dielectric anisotropy, low viscosity, and high birefringence. The spacers may be spherical with fibers having sizes from approximately 2 to 5 μm dispersed on the first homeotropic alignment layer 105 and/or the second homeotropic alignment layer 107. Glue can be dispensed on the edges of the electro-optic modulator 100. Liquid crystal may be filled by vacuum after the electro-optic modulator 100 is fabricated. The glass layer 103 and the reflective mirror 108 can be assembled using the spacers. The polarizer 101 is on the glass layer 103 opposite to the conductive layer 104. This configuration decreases cycle time for assembly of the electro-optic modulator 100. Driving voltage for the electro-optic modulator 100 can be decreased by using liquid crystals. Higher sensitivity can be obtained in the S-curve, which can improve defect detection capability versus a design using PDLC or NCAP layers. An exemplary S-curve can be seen in FIG. 5, which shows an embodiment of the electro-optic modulator 100 (VA Cell) with an existing design (HD NCAP).

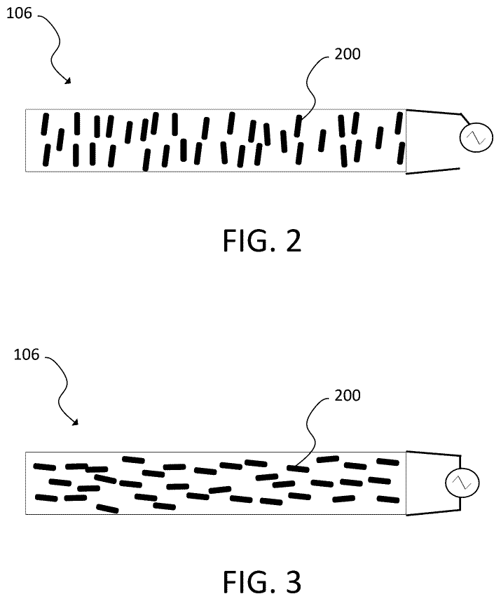

FIG. 2 illustrates a view of the liquid crystal layer 106 of an electro-optic modulator with a vertical alignment. FIG. 3 illustrates the liquid crystals 200 of the modulator material layer 106 of FIG. 2 after applying an electric field. In an instance, the liquid crystals 200 have a length from 2-4 nm. The liquid crystals 200 may be smaller than liquid crystal droplets. In an instance, the liquid crystal layer 106 may have a height from approximately 2-5 μm (e.g., 4 μm), though other dimensions are possible. A homeotropic alignment layer and negative dielectric liquid crystals may be used.

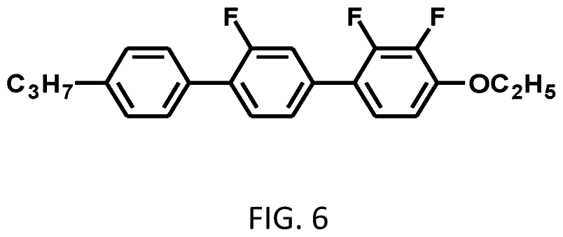

A dipole of the liquid crystals 200 may be in the middle rather than in the corners. The liquid crystals 200 may have biphenyl or triphenyl units with polar groups perpendicular to their molecular axis. One example of a liquid crystal structure is shown in FIG. 6.

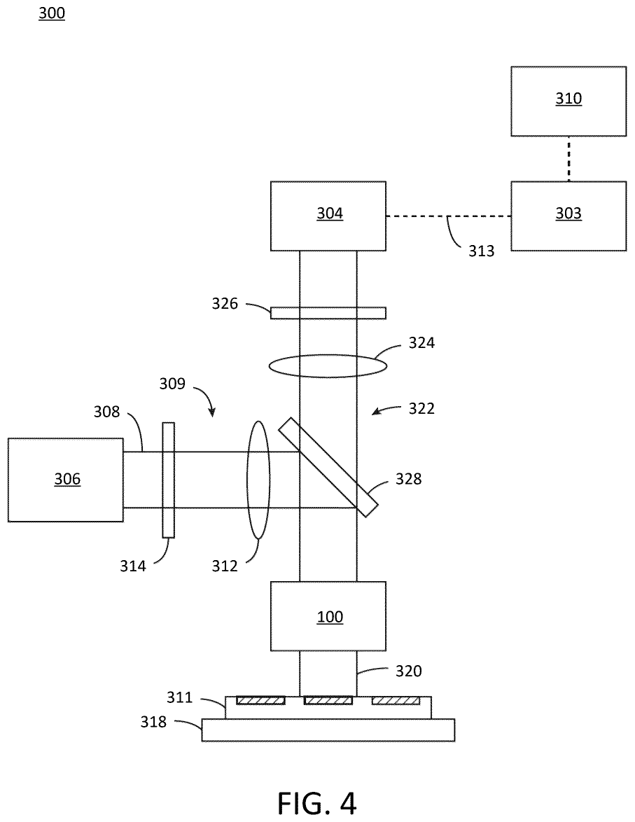

FIG. 4 is a conceptual view illustrating an imaging system 300. For the purposes of the present disclosure, the term “imaging system” is interchangeable with the term “imaging tool.” The imaging system 300 may generally include any type of imaging tool suitable, such as, but not limited to, voltage imaging. Voltage imaging may be employed to detect and measure defects in flat panel thin film transistors (TFT) arrays or other samples. The performance of the TFT array is simulated as if it were assembled into a TFT cell and then the characteristics of the TFT array are measured by indirectly measuring actual voltage distribution on the panel, or so-called voltage imaging, using an electro-optic modulator (e.g., electro-optic modulator 100). The voltage imaging may be performed by the imaging system 300. The imaging system 300 may include one or more components for checking such TFT arrays or other samples.

The electro-optic modulator 100 may be advantageous for a number of imaging tasks, such as to modulate a light source of the imaging system 300 to assist in detecting one or more defects of a sample 311, such as, but not limited to, TFT arrays, liquid crystal display (LCD) panels, OLED panels, and the like. The TFT arrays may be formed on a substrate, such as a clear plate of thin glass. The TFT arrays may include one or more printed layers. The printed layers may be formed on the substrate by a number of processes, such as, but not limited to, one or more material deposition steps, one or more lithography steps, one or more etching steps, or the like. The fabrication may occur in stages, where a material (e.g., indium tin oxide (ITO), etc.) is deposited over a previous layer or on the glass substrate, according to a process pattern. During fabrication, the printed layers are fabricated within selected tolerances to properly construct the final device. The printed layers may exhibit defects which are outside of the selected tolerances. Characteristics of the TFT array may be measured by the imaging system 300 to detect the defects.

In an embodiment, the imaging system 300 includes an illumination source 306 to generate illumination 308. The illumination 308 may include one or more selected wavelengths of light including, but not limited to, vacuum ultraviolet radiation (VUV), deep ultraviolet radiation (DUV), ultraviolet (UV) radiation, visible radiation, or infrared (IR) radiation. The illumination source 306 may further generate illumination 308 including any range of selected wavelengths. In embodiments, the illumination source 306 may include a spectrally-tunable illumination source to generate illumination 308 having a tunable spectrum.

The illumination source 306 can direct the illumination 308 to a sample 311 via an illumination pathway 309. The illumination pathway 309 may include one or more lenses 312 or additional illumination optical components 314 suitable for modifying and/or conditioning the illumination 308. For example, the one or more illumination optical components 314 may include, but are not limited to, one or more polarizers, one or more filters, one or more beam splitters, one or more diffusers, one or more homogenizers, one or more apodizers, one or more shapers, one or more shutters (e.g., mechanical shutters, electro-optical shutters, acousto-optical shutters, or the like), one or more aperture stops, and/or one or more field stops.

The imaging system 300 can include the electro-optic modulator 100. The electro-optic modulator 100 is disposed in a path of the illumination 308 from the illumination source 306. The electro-optic modulator 100 may modulate one or more characteristics of the illumination 308. During operation, light transmits through portions of the electro-optical modulator 100, and defects on or in the sample 311 can be detected by observing changes in the reflected or transmitted light. The electro-optic modulator 100 is separated from the sample 311 by an air gap. The electro-optic modulator 100 may be placed a select number of microns (e.g., between 5 -75 microns) above the surface of the sample 311 (e.g., the TFT array), and a voltage bias is applied across a transparent electrode of a layer of ITO on a surface of the electro-optic modulator 100. Thereupon, the electro-optic modulator 100 capacitively couples to the sample 311 so that an electric field associated with the sample 311 is sensed by one or more layers of the electro-optic modulator 100 (e.g., a layer including liquid crystals). The intensity of incident light transmitted through the liquid crystals of the electro-optic modulator are varied, (i.e., modulated), based on the electric field strength felt by the liquid crystals. For example, in areas where a normal pixel is located, a localized voltage potential is impressed (e.g., a capacitive coupling between the sample 311 and the electro-optic modulator 100) causing one or more films of the electro-optical modulator 100 to be locally translucent. In the locally translucent regions, light from the light source 306 is allowed to pass through the electro-optical modulator 100 and reflect from the sample 311, for passing through to a collection pathway 322 (e.g., for capture by detector 304). By way of another example, in areas where no voltage potential is impressed (e.g., no capacitive coupling), one or more films of the electro-optical modulator 100 remain locally opaque. In the case where the electro-optical modulator 100 is locally opaque, light from light source 306 is scattered or otherwise prevented from passing through to the sample 311. Thus, a transmission-voltage (T-V) curve may be determined by applying the voltage. The intrinsic switching voltage of the electro-optic modulator 100 may correspond to the voltage across the electro-optic modulator 100 at which light transmission through the electro-optic modulator 100 has a maximum sensitivity to a change in voltage. For example, the switching voltage may correspond to the electric field strength at which a given percentage of liquid crystal molecules are substantially aligned with the electric field allowing for the light transmission.

The sample 311 can include a TFT array. For example, the sample 311 may include pixel elements disposed between inactive regions. The sample stage 318 may include any device suitable for positioning the sample 311 within the imaging system 300.

A detector 304 can be configured to capture radiation emanating from the sample 311 (e.g., sample light 320) through a collection pathway 322. For example, the collection pathway 322 may include, but is not required to include, the electro-optic modulator 100, a collection lens (e.g., an objective lens), or one or more additional collection pathway lenses 324. In this regard, a detector 304 may receive radiation reflected or scattered (e.g., via specular reflection, diffuse reflection, and the like) from the sample 311 or generated by the sample 311 (e.g., luminescence associated with absorption of the illumination 308, or the like).

The system 300 may include, but is not limited to, a controller 303. The controller 303 may include one or more processors and memory, and may include or be coupled to a user interface 310.

The collection pathway 322 may further include any number of collection optical components 326 to direct and/or modify illumination collected by the electro-optic modulator 100 including, but not limited to one or more filters, one or more polarizers, or one or more blocks. Additionally, the collection pathway 322 may include field stops to control the spatial extent of the sample imaged onto the detector 304 or aperture stops to control the angular extent of illumination from the sample used to generate an image on the detector 304. In another embodiment, the collection pathway 322 includes an aperture stop located in a plane conjugate to the back focal plane of an optical element to provide telecentric imaging of the sample. In embodiments, the imaging system 300 includes a beam splitter 328 oriented such that the electro-optic modulator 100 may simultaneously direct the illumination 308 to the sample 311 and collect radiation emanating from the sample 311.

The detector 304 may include any type of optical detector suitable for measuring illumination received from the sample 311. For example, the detector 304 may include, but is not limited to, a charge-coupled device (CCD) detector, a time-delay integration (TDI) detector, a photomultiplier tube (PMT), an avalanche photodiode (APD), a complementary metal-oxide-semiconductor (CMOS) sensor, or the like. In another embodiment, the detector 304 may include a spectroscopic detector suitable for identifying wavelengths of light emanating from the sample 311.

The controller 303 can be communicatively coupled to a detector 304. The controller 303 may include one or more processors configured to execute any of various process steps. In embodiments, the controller 303 is configured to generate and provide one or more control signals configured to perform one or more adjustments to one or more process tools based on image signals 313 from the detector 304.

The one or more processors of the controller 303 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the imaging system 300, as described throughout the present disclosure. Moreover, different subsystems of the system 300 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 303 may include one or more controllers housed in a common housing or within multiple housings. In this way, any controller or combination of controllers may be separately packaged as a module suitable for integration into imaging system 300. Further, the controller 303 may analyze data received from the detector 304 and feed the data to additional components within the imaging system 300 or external to the imaging system 300.

A memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller 303. For instance, the one or more processors of controller 303 may access a remote memory (e.g., server), accessible through a network (e.g., internet, intranet and the like).

A user interface 310 can be communicatively coupled to the controller 303. The user interface 310 may include, but is not limited to, one or more desktops, laptops, tablets, and the like. In embodiments, the user interface 310 includes a display used to display data of the system 300 to a user. The display of the user interface 310 may include any display known in the art. For example, the display may include, but is not limited to, a liquid crystal display (LCD), an organic light-emitting diode (OLED) based display, or a cathode ray tube (CRT) display. Those skilled in the art should recognize that any display device capable of integration with a user interface 310 is suitable for implementation in the present disclosure. In embodiments, a user may input selections and/or instructions responsive to data displayed to the user via a user input device of the user interface 310.

As used throughout the present disclosure, the term “sample” generally refers to a substrate formed of a semiconductor or non-semiconductor material (e.g., thin filmed glass or the like). For example, a semiconductor or non-semiconductor material may include, but is not limited to, monocrystalline silicon, gallium arsenide, indium phosphide, or a glass material. A sample may include one or more layers. For example, such layers may include, but are not limited to, a resist (including a photoresist), a dielectric material, a conductive material, and a semiconductive material. Many different types of such layers are known in the art, and the term sample as used herein is intended to encompass a sample on which all types of such layers may be formed. One or more layers formed on a sample may be patterned or un-patterned. For example, a sample may include a plurality of dies, each having repeatable patterned features. Formation and processing of such layers of material may ultimately result in completed devices. Many different types of devices may be formed on a sample, and the term sample as used herein is intended to encompass a sample on which any type of device known in the art is being fabricated. Further, for the purposes of the present disclosure, the term sample and wafer should be interpreted as interchangeable. In addition, for the purposes of the present disclosure, the terms patterning device, mask and reticle should be interpreted as interchangeable.

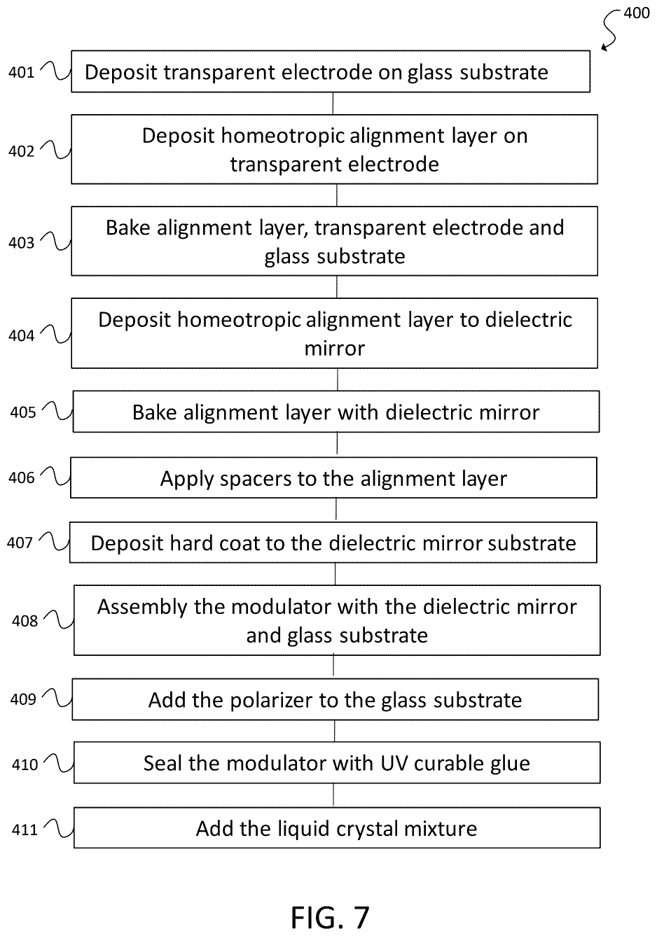

FIG. 7 is a flowchart of an embodiment of a method 400 to assemble an electro-optic modulator, such as the electro-optic modulator 100. At 401, a transparent electrode, such as the conductive layer 104, is deposited on a glass substrate, such as the glass layer 103. A homeotropic alignment layer, such as the first homeotropic alignment layer 105, is deposited on the transparent electrode at 402. The alignment layer, transparent electrode, and glass substrate are baked at 403. Then a homeotropic alignment layer, such as the second homeotropic alignment layer 107, is deposited on a dielectric mirror, such as the reflective mirror 108, at 404 and baked at 405. At 406, spacers are applied to one or both of the homeotropic alignment layers. A hard coat, such as the hard coating layer 109, is then deposited on the dielectric mirror substrate at 407. The modulator is assembled at 408 with the dielectric mirror and glass substrate. A polarizer, such as the polarizer 101, is added to the glass substrate at 409. The modulator can then be sealed with UV-curable glue at 410 and liquid crystal mixture can be added at 211.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. An electro-optic modulator comprising:
a glass layer;
a first homeotropic alignment layer disposed on the glass layer;
a liquid crystal layer disposed on the first homeotropic alignment layer opposite the glass layer, wherein the liquid crystal layer includes a negative dielectric liquid crystal;
a second homeotropic alignment layer disposed on the liquid crystal layer opposite the first homeotropic alignment layer; and
a reflective mirror disposed on the second homeotropic alignment layer opposite the liquid crystal layer.

2. The electro-optic modulator of claim 1, further comprising a polarizer disposed on the glass layer opposite the first homeotropic alignment layer.

3. The electro-optic modulator of claim 2, further comprising an antireflective layer disposed between the polarizer and the first homeotropic alignment layer.

4. The electro-optic modulator of claim 1, further comprising a conductive layer disposed between the glass layer and the first homeotropic alignment layer.

5. The electro-optic modulator of claim 4, wherein the conductive layer is a transparent electrode.

6. The electro-optic modulator of claim 1, further comprising a hard coating layer disposed on the reflective mirror oppositive the second homeotropic alignment layer.

7. The electro-optic modulator of claim 1, wherein the liquid crystal layer includes vertical alignment layers.

8. An imaging system comprising:
an illumination source configured to generate illumination;
a stage configured to hold a sample;
a detector to generate an image of at least a portion of the sample; and
an electro-optic modulator disposed in a path of illumination from the illumination source and separated from the sample by an air gap, wherein the electro-optic modulator includes:
a glass layer;
a first homeotropic alignment layer disposed on the glass layer;
a liquid crystal layer disposed on the first homeotropic alignment layer opposite the glass layer, wherein the liquid crystal layer includes a negative dielectric liquid crystal;
a second homeotropic alignment layer disposed on the liquid crystal layer opposite the first homeotropic alignment layer; and
a reflective mirror disposed on the second homeotropic alignment layer opposite the liquid crystal layer.

9. The imaging system of claim 8, wherein the electro-optic modulator further comprises a polarizer disposed on the glass layer opposite the first homeotropic alignment layer.

10. The imaging system of claim 9, wherein the electro-optic modulator further comprises an antireflective layer disposed between the polarizer and the first homeotropic alignment layer.

11. The imaging system of claim 8, wherein the electro-optic modulator further comprises a conductive layer disposed between the glass layer and the first homeotropic alignment layer.

12. The imaging system of claim 11, wherein the conductive layer is a transparent electrode.

13. The imaging system of claim 8, wherein the electro-optic modulator further comprises a hard coating layer disposed on the reflective mirror oppositive the second homeotropic alignment layer.

14. The imaging system of claim 8, wherein the liquid crystal layer includes vertical alignment layers.
